(19) United States
(12) Patent Application Publication
(10) Pub. No.: US 2019/0283442 A1
(43) Pub. Date: Sep. 19, 2019

(54) Ink Supply Device, Ink-Jet Recording Apparatus, and Ink Supply Method

(71) Applicant: Kyocera Document Solutions Inc., Osaka (JP)

(72) Inventor: Kenichi Satake, Osaka (JP)

(73) Assignee: Kyocera Document Solutions Inc.

(21) Appl. No.: 16/354,112

(22) Filed: Mar. 14, 2019

(30) Foreign Application Priority Data
Mar. 16, 2018 (JP) 2018-049394
Feb. 8, 2019 (JP) 2019-022038

(51) Int. Cl. B41J 2/175

(52) U.S. Cl. CPC B41J 2/17566; B41J 2/17546; B41J 2/17509

(57) ABSTRACT

An ink supply device includes a first tank, a second tank, a first calculator, and a second calculator. The first tank stores an ink. The second tank stores the ink supplied from the first tank. The first calculator calculates an amount of the ink in the second tank. The second calculator calculates an amount of the ink in the first tank based on the amount of the ink in the second tank.

### INCORPORATION BY REFERENCE

This application is based upon, and claims the benefit of priority from, corresponding Japanese Patent Applications No. 2018-049394 and No. 2019-022038 filed in the Japan Patent Office on Mar. 16, 2018, and Feb. 8, 2019, respectively, the entire contents of which are incorporated herein by reference.

### BACKGROUND

Unless otherwise indicated herein, the description in this section is not prior art to the claims in this application and is not admitted to be prior art by inclusion in this section.

There has been known a typical liquid droplet ejecting apparatus configured to detect an amount of ink in an ink cartridge. As such a liquid droplet ejecting apparatus, there has been proposed a liquid droplet ejecting apparatus that includes an ink tank, a sub tank, a first ink detector, and a second ink detector. The liquid droplet ejecting apparatus determines whether the ink tank is empty or not based on detection results by the first ink detector and the second ink detector. When the ink tank is empty, the ink tank is replaced. When the ink tank is replaced, the liquid droplet ejecting apparatus updates an amount of the ink in the ink tank to an initial capacity value, and supplies the ink from the ink tank to the sub tank.

### SUMMARY

An ink supply device according to one aspect of the disclosure includes a first tank, a second tank, a first calculator, and a second calculator. The first tank stores an ink. The second tank stores the ink supplied from the first tank. The first calculator calculates an amount of the ink in the second tank. The second calculator calculates an amount of the ink in the first tank based on the amount of the ink in the second tank.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an ink-jet recording apparatus that includes an ink supply device according to one embodiment of the disclosure;

FIG. 2 illustrates the ink supply device according to the one embodiment;

FIG. 3 illustrates a control block diagram of the ink supply device according to the one embodiment; and

FIG. 4 illustrates a process executed by a control unit of the ink supply device according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of the disclosure by referring to the drawings. In the drawings, identical reference numerals are used to the identical or corresponding parts not to repeat explanations.

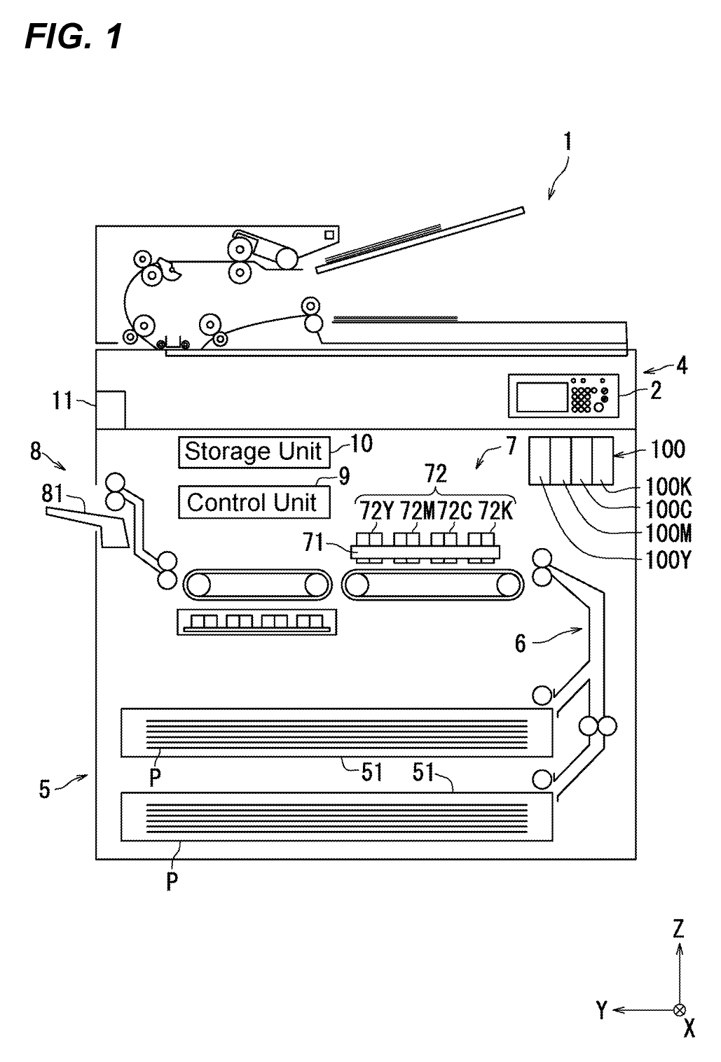

First, with reference to FIG. 1, a configuration of an ink-jet recording apparatus 1 will be described. FIG. 1 illustrates the ink-jet recording apparatus 1 that includes an ink supply device 100 according to the embodiment of the disclosure.

As illustrated in FIG. 1, the ink-jet recording apparatus 1 includes an operation panel 2, a paper-sheet housing portion 5, a conveyance unit 6, a recording unit 7, the ink supply device 100, a discharge device 8, a control unit 9, and a storage unit 10.

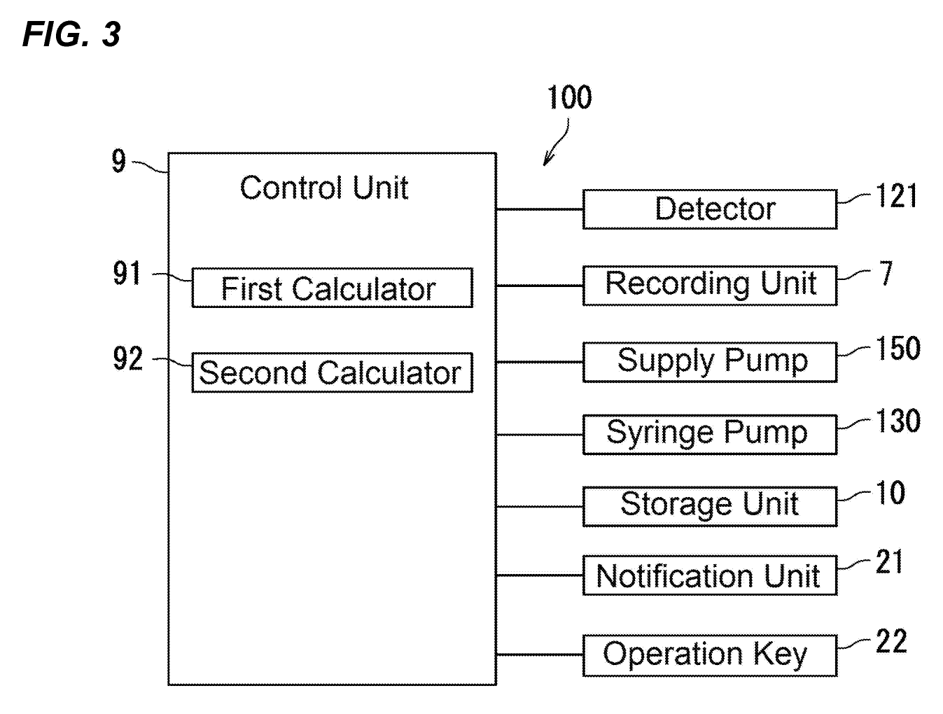

The operation panel 2 accepts an instruction of a job given from a user to the ink-jet recording apparatus 1. The operation panel 2 includes a notification unit 21 and a plurality of operation keys 22 (see FIG. 3). Upon accepting the instruction from the user, the operation panel 2 transmits a signal indicating the instruction from the user to the control unit 9. The notification unit 21 includes, for example, a liquid crystal display or an organic EL display.

The notification unit 21 gives notice of information from the ink-jet recording apparatus 1. For example, the notification unit 21 gives notice of the information from the ink-jet recording apparatus 1 to the user.

The operation keys 22 accept an input of the instruction from the user. The user can perform various settings of the ink-jet recording apparatus 1 by operating the operation keys 22 to input the instruction.

The paper-sheet housing portion 5 includes a plurality of cassettes 51. Specifically, the paper-sheet housing portion 5 includes the plurality of cassettes 51 to house paper sheets P. The paper sheet P fed from the cassette 51 is conveyed to the conveyance unit 6.

The conveyance unit 6 conveys the paper sheet P so as to pass through a lower side of the recording unit 7. The conveyance unit 6 conveys the paper sheet P, which has passed through the lower side of the recording unit 7, to the discharge device 8.

The recording unit 7 discharges inks to form an image on the paper sheet P. The recording unit 7 includes a head housing 71 and four line heads 72. The head housing 71 supports the four line heads 72. The four line heads 72 discharge respective inks of corresponding colors.

The line head 72 that discharges a yellow ink is indicated as a line head 72Y. The line head 72 that discharges a magenta ink is indicated as a line head 72M. The line head 72 that discharges a cyan ink is indicated as a line head 72C. The line head 72 that discharges a black ink is indicated as a line head 72K.

The ink supply device 100 supplies the inks to the recording unit 7. Four ink supply devices 100 are located. A first ink supply device 100Y supplies the ink to the line head 72Y. A second ink supply device 100M supplies the ink to the line head 72M. A third ink supply device 100C supplies the ink to the line head 72C. A fourth ink supply device 100K supplies the ink to the line head 72K.

The discharge device 8 includes a discharge tray 81. The discharge device 8 discharges the paper sheet P outside a main body housing. The paper sheet P discharged outside the main body housing is placed on the discharge tray 81.

The control unit 9 includes a processor such as a Central Processing Unit (CPU). The control unit 9 executes a control program to control behaviors of respective units in the ink-jet recording apparatus 1. The control unit 9 includes an integrated circuit for an image formation process. The integrated circuit for the image formation process includes, for example, an Application Specific Integrated Circuit (ASIC).

The storage unit 10 stores data. The storage unit 10 includes a storage device and a semiconductor memory. The storage device includes, for example, a Hard Disk Drive (HDD) and/or a Solid State Drive (SSD). The semiconductor memory constitutes, for example, a Random Access Memory (RAM) and a Read Only Memory (ROM). The storage unit 10 stores the control program.

The storage unit 10 stores discharge amount data. The discharge amount data includes a discharge amount of the ink per pixel and a discharge amount of the ink discharged for a cleaning operation. The storage unit 10 stores an amount of the ink discharged in recording the image and an amount of the ink discharged for the cleaning.

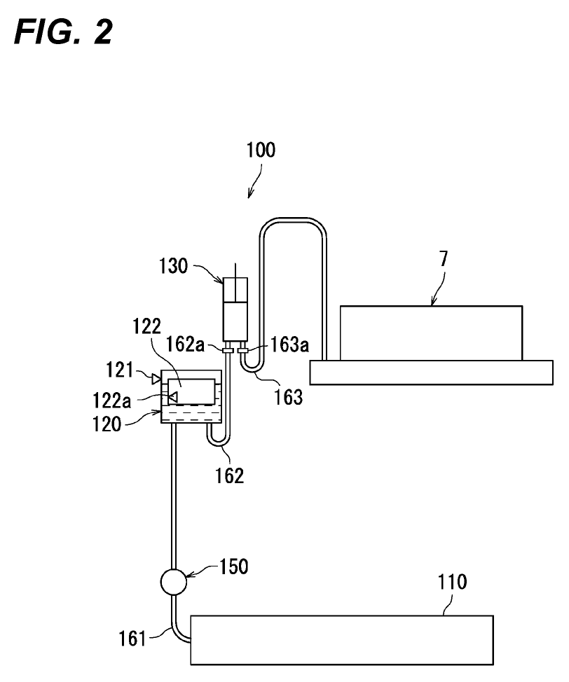

Next, the ink supply device 100 will be explicated with reference to FIG. 2. FIG. 2 illustrates the ink supply device 100. As illustrated in FIG. 2, the ink supply device 100 includes an ink tank 110, a sub tank 120, a syringe pump 130, a supply pump 150, a first pipe 161, a second pipe 162, a third pipe 163, a first valve 162a, and a second valve 163a. The ink supply device 100 operates in accordance with the instruction from the control unit 9.

The ink tank 110 houses the ink. The ink tank 110 corresponds to an exemplary “first tank.” The ink in the ink tank 110 includes the ink discharged for recording the image and the ink discharged for the cleaning. The ink tank 110 is located for each type of ink color. Specifically, the ink tank 110 includes an ink tank that stores the yellow ink, an ink tank that stores the magenta ink, an ink tank that stores the cyan ink, and an ink tank that stores the black ink. Each ink tank 110 is connected to the line head 72 of its identical color type via the pipe.

The ink tank 110 may include a remaining amount storage device of the ink. The remaining amount storage device stores remaining amounts of the inks in the ink tank 110. The remaining amount storage device stores the amount of the ink discharged for recording the image and the amount of the ink discharged for the cleaning.

The sub tank 120 stores the ink. The sub tank 120 corresponds to an exemplary “second tank.” The sub tank 120 includes a float 122 and a detector 121. The detector 121 is, for example, a “Hall IC.” The float 122 moves up and down inside the sub tank 120 in accordance with rising and falling of a liquid surface of the ink in the sub tank 120. The float 122 includes a magnet holder and a magnet 122a. The magnet holder holds the magnet 122a. The magnet 122a generates a magnetic force. The sub tank 120 includes a through-hole (not illustrated). The through-hole communicates with atmosphere. The through-hole is located above the liquid surface of the ink in the sub tank 120.

The detector 121 detects presence or absence of the ink in the sub tank 120. The detector 121 is located on an outer wall of the sub tank 120. The detector 121 is located on the outer wall of the sub tank 120 at a predetermined height. The detector 121 has an ON state and an OFF state changed depending on the magnetic force of the magnet 122a. The ON state is a state where the detector 121 has detected the magnetic force of the magnet 122a. The OFF state is a state where the detector 121 has not detected the magnetic force of the magnet 122a.

The detector 121 outputs a signal to the control unit 9 when the magnetic force of the magnet 122a is detected. Specifically, when the ink has been supplied to the sub tank 120 and the magnet 122a of the float 122 has risen to the height where the detector 121 is located, the detector 121 detects the magnetic force of the magnet 122a and outputs the signal to the control unit 9. Consequently, the detector 121 can detect the presence of the ink.

The detector 121 does not output the signal to the control unit 9 when the magnetic force of the magnet 122a is not detected. Specifically, when the ink in the sub tank 120 has been delivered by the syringe pump 130 and the magnet 122a of the float 122 has moved down below the height where the detector 121 is located, the detector 121 does not detect the magnetic force of the magnet 122a and not output the signal to the control unit 9. Consequently, the detector 121 can detect the absence of the ink.

The syringe pump 130 discharges the ink stored in the sub tank 120 to the third pipe 163. The syringe pump 130 includes a cylinder and a piston.

The cylinder stores the ink in the sub tank 120. The cylinder has a cylinder portion, a lid portion, and a bottom portion. The bottom portion of the cylinder includes an inlet and an outlet.

The piston moves inside the cylinder. The piston is formed in a columnar shape or a cylindrical shape. A part of the piston is inserted into the cylinder. The piston moves from the bottom portion to the lid portion of the cylinder following the instruction from the control unit 9.

When the piston moves to the lid portion side, the ink flows in the cylinder from the sub tank 120 via the second pipe 162 and the inlet. The lid portion side indicates a direction in which the cylinder separates from the bottom portion of the piston. When the piston moves to the bottom portion side, the ink flows out of the cylinder to the recording unit 7 via the outlet and the third pipe 163. The bottom portion side indicates a direction in which the cylinder approaches the bottom portion of the piston.

The supply pump 150 supplies the ink stored in the ink tank 110 to the sub tank 120. The supply pump 150 supplies the ink until the detector 121 becomes the ON state following the instruction from the control unit 9.

The first pipe 161 connects the ink tank 110 to the sub tank 120. The supply pump 150 is arranged on the first pipe 161. The second pipe 162 connects the sub tank 120 to the syringe pump 130. The first valve 162a is arranged on the second pipe 162. The third pipe 163 connects the syringe pump 130 to the recording unit 7. The second valve 163a is arranged on the third pipe 163.

The first valve 162a controls flowing in and flowing out of the ink through opening and closing of the valve. The first valve 162a is opened and closed following the instruction from the control unit 9. Specifically, the first valve 162a is turned from the open state to the closed state immediately before the piston starts moving to the bottom portion side, and turned from the closed state to the open state immediately after the piston terminates moving to the bottom portion side. That is, the first valve 162a is kept in the closed state during the move of the piston to the bottom portion side, while the first valve 162a is kept in the open state in the other period.

The second valve 163a controls flowing in and flowing out of the ink through opening and closing of the valve. The second valve 163a is opened and closed following the instruction from the control unit 9. Specifically, the second valve 163a is turned from the open state to the closed state immediately before the piston starts moving to the lid portion side, and turned from the closed state to the open state immediately after the piston terminates moving to the lid portion side. That is, the second valve 163a is kept in the closed state during the move of the piston to the lid portion side. In the other period, the second valve 163a is kept in the open state. When the second valve 163a is in the open state, the first valve 162a is kept in the closed state. When the second valve 163a is in the closed state, the first valve 162a is kept in the open state.

Next, with reference to FIG. 3, the control unit 9 according to the embodiment of the disclosure will be described. FIG. 3 illustrates a control block diagram of the ink supply device 100. As illustrated in FIG. 3, the control unit 9 is connected to each of the recording unit 7, the storage unit 10, the notification unit 21, the plurality of operation keys 22, the detector 121, the syringe pump 130, and the supply pump 150. As illustrated in FIG. 3, the control unit 9 includes a first calculator 91 and a second calculator 92. Specifically, the processor of the control unit 9 executes the computer program stored in the storage device of the storage unit 10 to function as the first calculator 91 and the second calculator 92.

The first calculator 91 calculates the amount of the ink in the sub tank 120. Specifically, the first calculator 91 calculates the amount of the ink delivered from the sub tank 120. The amount of the ink delivered from the sub tank 120 corresponds to an exemplary “delivered ink amount.” The delivered ink amount is a sum of the amount of the ink discharged for recording the image and the amount of the ink discharged for the cleaning.

When the first calculator 91 calculates the ink discharged for recording the image, the first calculator 91 calculates the amount of the ink discharged for recording the image based on a discharge amount of the ink per pixel stored in the storage unit 10 and the number of pixels of the recorded image. When the first calculator 91 calculates the amount of the ink discharged for the cleaning, the first calculator 91 calculates the amount of the ink discharged for the cleaning based on a discharge amount of the ink discharged in the cleaning operation and the number of times of the cleaning operations.

The first calculator 91 starts the calculation of the amount of the ink in the sub tank 120 based on the detection result by the detector 121. Specifically, the first calculator 91 calculates the delivered ink amount from the detection of the presence of the ink in the sub tank 120 by the detector 121 to the detection of the absence of the ink in the sub tank 120 by the detector 121. The ink supply to the sub tank 120 turns the detector 121 from the OFF state to the ON state. The ink delivery from the sub tank 120 turns the detector 121 from the ON state to the OFF state. The first calculator 91 repeatedly calculates the delivered ink amount in the period where the detector 121 turns in the OFF state from the ON state until the ink in the ink tank 110 is used up.

The second calculator 92 calculates the amount of the ink in the ink tank 110. Specifically, the second calculator 92 calculates the amount of the ink in the ink tank 110 based on the amount of the ink in the sub tank 120. Further specifically, the second calculator 92 calculates an ink remaining amount value of the ink tank 110 based on the delivered ink amount of the sub tank 120. Since the ink in the ink tank 110 is supplied to the sub tank 120, the calculation of the ink remaining amount value of the ink tank 110 cannot obtain an accurate ink remaining amount value. In view of this, the second calculator 92 calculates the ink remaining amount value of the ink tank 110 from the amount of the ink in the sub tank 120. The calculation of the ink remaining amount value of the ink tank 110 from the amount of the ink in the sub tank 120 ensures the accurate calculation of the ink remaining amount value of the ink tank 110.

When the ink tank 110 is replaced, the second calculator 92 subtracts the delivered ink amount in the period where the detector 121 turns in the OFF state from the ON state, calculated by the first calculator 91, from the amount of the ink in the ink tank 110. Specifically, when the ink tank 110 is replaced, the second calculator 92 subtracts the delivered ink amount calculated by the first calculator 91 from the maximum capacity value of the ink tank 110. Consequently, the second calculator 92 can calculate the accurate ink remaining amount value of the ink tank 110.

When the ink tank 110 is replaced, the ink has been used up also in the sub tank 120 in some cases. In such a case, the ink is supplied to the sub tank 120 from the ink tank 110 when the ink tank 110 is replaced. Meanwhile, the replacement of the ink tank 110 causes the control unit 9 to update the ink remaining amount value stored in the storage unit 10 to the maximum capacity value of the ink tank 110. Accordingly, the ink remaining amount value stored in the storage unit 10 is the maximum capacity value of the ink tank 110 while actually the ink in the ink tank 110 has decreased by the amount of the ink supplied to the sub tank 120. That is, the ink remaining amount value of the ink tank 110 is inaccurate. Therefore, in this embodiment, when the ink tank 110 is replaced, the second calculator 92 subtracts the delivered ink amount in the period where the detector 121 turns in the OFF state from the ON state, calculated by the first calculator 91, from the maximum capacity value of the ink tank 110. This ensures the accurate calculation of the ink remaining amount value of the ink tank 110.

The second calculator 92 calculates the amounts of the ink in the ink tank 110 for respective color types.

The second calculator 92 may subtract the delivered ink amount from the ink remaining amount value of the ink tank 110 every time that the image recording and the cleaning operation are executed. Consequently, the second calculator 92 can calculate the accurate ink remaining amount value of the ink tank 110.

The control unit 9 determines the presence or absence of the ink in the sub tank 120 based on the detection result by the detector 121. Specifically, when the detector 121 turns in the ON state, the control unit 9 determines the presence of the ink in the sub tank 120. When the detector 121 turns in the OFF state, the control unit 9 determines the absence of the ink in the sub tank 120. Consequently, the control unit 9 can determine the presence or absence of the ink in the sub tank 120.

The control unit 9 determines whether the OFF state of the detector 121 continues for a predetermined time or not. When the OFF state of the detector 121 continues for the predetermined time, the ink tank 110 is empty. That is, the control unit 9 can determine the absence of the ink in the ink tank 110 from the detection result by the detector 121 of the sub tank 120. Consequently, the absence of the ink in the ink tank 110 can be determined without a sensor located on the ink tank 110.

The control unit 9 determines whether the ink tank 110 has been replaced or not. When the ink tank 110 is inserted, the signal is transmitted to the control unit 9, thus the control unit 9 can determine the replacement of the ink tank 110.

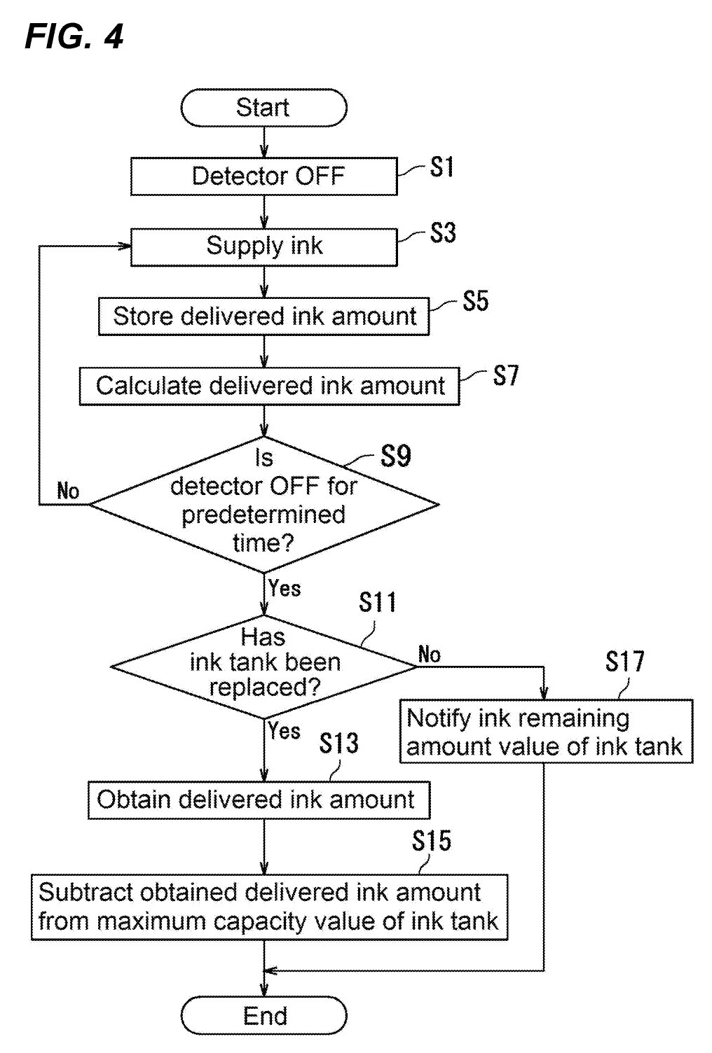

Next, with reference to FIG. 4, a description will be given of a flow of a process executed by the control unit 9. FIG. 4 illustrates the process executed by the control unit 9. As illustrated in FIG. 4, the process executed by the control unit 9 includes Step 51 to Step S17.

As illustrated in FIG. 4, when the process executed by the control unit 9 starts, Step 51 is executed. In Step 51, the detector 121 turns in the OFF state. That is, the detector 121 detects the absence of the ink in the sub tank 120.

In Step S3, the control unit 9 controls the supply pump 150 to supply the ink to the sub tank 120. Specifically, the control unit 9 controls the supply pump 150 to supply the ink until the detector 121 turns in the ON state.

In Step S5, the control unit 9 controls the storage unit 10 to store the delivered ink amount.

In Step S7, the first calculator 91 calculates the delivered ink amount. Specifically, the first calculator 91 starts the calculation of the delivered ink amount after the detector 121 turns in the ON state.

In Step S9, the control unit 9 determines whether the detector 121 has turned in the OFF state or not. Specifically, the control unit 9 determines whether the OFF state of the detector 121 continues for the predetermined time or not. When the OFF state of the detector 121 continues for the predetermined time (Yes, at Step S9), the process proceeds to Step S11. When the OFF state of the detector 121 does not continue for the predetermined time (No, at Step S9), the process returns to Step S3.

In Step S11, the control unit 9 determines whether the ink tank 110 has been replaced or not. When the ink tank 110 has been replaced (Yes, at Step S11), the process proceeds to Step S13. When the ink tank 110 has not been replaced (No, at Step S11), the process proceeds to Step S17.

In Step S13, the control unit 9 obtains the delivered ink amount from the storage unit 10.

In Step S15, the second calculator 92 subtracts the delivered ink amount obtained from the storage unit 10 from the maximum capacity value of the ink tank 110.

In Step S17, the control unit 9 controls the notification unit 21 such that the notification unit 21 gives notice of the ink remaining amount value of the ink tank 110.

In Step S17, the control unit 9 may reset the delivered ink amount stored in the storage unit 10. The control unit 9 updates the ink remaining amount value stored in the storage unit 10 of the ink supply device 100 to the ink remaining amount value calculated by the second calculator 92. When the ink tank 110 includes the remaining amount storage device, the control unit 9 may update the ink remaining amount value stored in the storage unit 10 and the ink remaining amount value stored in the remaining amount storage device to the ink remaining amount value calculated by the second calculator 92.

In this description, Step S7 corresponds to an exemplary “first calculating of an amount of an ink in the second tank.” Step S15 corresponds to an exemplary “second calculating of an amount of an ink in the first tank (the ink tank 110) based on the amount of the ink in the second tank.”

The embodiments of the disclosure have been described above with reference to the drawings (FIGS. 1 to 4). However, the disclosure is not limited to the embodiment described above and is implemented in various kinds of aspects without departing from the gist of the disclosure. A plurality of components disclosed in the above-described embodiments can be appropriately combined to take various kinds of embodiments. For example, some components may be deleted from all components disclosed in the embodiments. Furthermore, the components may be appropriately combined across different embodiments. The drawings schematically illustrate components mainly for easy understanding, and the thickness, length, number, distance, and similar factor of the illustrated components are different from the actual thickness, length, number, distance, and similar factor for the convenience of preparing the drawings. The velocities, materials, shapes, dimensions, and similar factors of the respective components described in the embodiment described above are merely examples and are not particularly limited, thus they are variously changeable without substantially departing from the configuration of the disclosure.

The disclosure is applicable to fields of an ink supply device, an ink-jet recording apparatus, and an ink supply method.

### EXEMPLARY EMBODIMENT OF THE DISCLOSURE

The ink supply device according to the disclosure includes the first tank, the second tank, the first calculator, and the second calculator. The first tank stores the ink. The second tank stores the ink supplied from the first tank. The first calculator calculates the amount of the ink in the second tank. The second calculator calculates the amount of the ink in the first tank based on the amount of the ink in the second tank.

The ink-jet recording apparatus according to the disclosure includes the ink supply device.

The ink supply method executed by the ink supply device includes a first calculating step and a second calculating step. The ink supply device includes the first tank and the second tank. The first calculating step calculates the amount of the ink in the second tank. The second calculating step includes calculating the amount of the ink in the first tank based on the amount of the ink in the second tank.

### Effect of the Disclosure

The ink supply device of the disclosure ensures accurate calculation of the ink remaining amount value.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An ink supply device comprising:
a first tank that stores an ink;
a second tank that stores the ink supplied from the first tank;
a first calculator that calculates an amount of the ink in the second tank; and
a second calculator that calculates an amount of the ink in the first tank based on the amount of the ink in the second tank.

2. The ink supply device according to claim 1,
wherein the first calculator calculates a delivered ink amount delivered from the second tank.

3. The ink supply device according to claim 2,
wherein the second calculator subtracts the delivered ink amount from the amount of the ink in the first tank.

4. The ink supply device according to claim 1,
wherein the second tank includes a detector that detects presence or absence of the ink in the second tank, and
the first calculator starts the calculation of the amount of the ink in the second tank based on a detection result by the detector.

5. The ink supply device according to claim 2,
wherein the second calculator subtracts the delivered ink amount from the amount of the ink in the first tank when the first tank has been replaced.

6. An ink-jet recording apparatus comprising
the ink supply device according to claim 1.

7. An ink supply method executed by an ink supply device, the ink supply device including a first tank and a second tank, the ink supply method comprising:
first calculating of an amount of an ink in the second tank; and
second calculating of an amount of an ink in the first tank based on the amount of the ink in the second tank.
